(19) United States
(12) Patent Application Publication
(10) Pub. No.: US 2012/0189877 A1
(43) Pub. Date: Jul. 26, 2012

(54) COMPOSITE CARBON FIBER ELECTRODES INCORPORATING POROUS HIGH SURFACE AREA CARBON

(75) Inventors: John P. Ferraris, Coppell, TX (US); Qiang Wu, Plano, TX (US); Marilou E. Dela Cruz, Dallas, TX (US)

(73) Assignees: Solarno, Inc., Coppell, TX (US); The Board of Regents of the University of Texas System, Austin, TX (US)

(21) Appl. No.: 13/357,431

(22) Filed: Jan. 24, 2012

Related U.S. Application Data
(60) Provisional application No. 61/435,577, filed on Jan. 24, 2011.

(51) Int. Cl. H01M 4/60; H01M 16/00; B29C 44/20; H01G 9/155; H01M 4/583; H01M 10/02; B82Y 30/00

(52) U.S. Cl. 429/9; 429/231.8; 429/212; 429/188; 264/415; 361/502; 977/780

(57) ABSTRACT

The claimed invention uses activated carbon fibers that incorporate porous carbon with a suitable pore size to maximize capacitance. The porous carbon material is prepared using a template, followed by incorporation into a matrix polymer and electrospinning of the mixture. Subsequent thermal treatments retain the fiber form, and a composite carbon fiber incorporating templated porous carbon is attained. The resulting electrode is binder free and 100% electrochemically active. Energy densities up to 41 Wh/kg in energy density 1.5 kW/kg in power density (electrode weight only) have been achieved.

### CROSS-REFERENCES TO RELATED APPLICATIONS

This application claims the benefit under 35 U.S.C. §119(e) of U.S. Provisional Patent Application Set. No. 61/435,577 filed Jan. 24, 2011, which is incorporated herein by reference in its entirety as if fully set forth herein.

### STATEMENT REGARDING FEDERALLY-SPONSORED RESEARCH OR DEVELOPMENT

This invention was made with government support under Grant No. IIP-0930699 awarded by the National Science Foundation. The government has certain rights in the invention.

### FIELD OF THE INVENTION

The present invention relates to an electrochemical cell, which may be a battery or a supercapacitor or both, and which uses an electrode made from composite carbon fibers. In accordance with the present invention, the composite carbon fibers comprise porous carbon and are made using a templating method.

### BACKGROUND OF THE INVENTION

In recent years, a lot of time and attention has been focused on attempts to improve the performance of various types of electrochemical cells, including supercapacitors, batteries and supercapacitor/battery combinations.

Current commercial carbon-based supercapacitors typically have energy and power densities of 5 Wh/kg and 5 kW/kg, respectively. Most of them also use either aqueous or organic electrolytes. As a consequence, the single cell voltage cannot exceed 3V, which limits its energy and power densities. Use of ionic liquid electrolytes which allow working voltages 3.5 V or higher and result in higher energy and power densities, is desirable. However, use of ionic liquid electrolytes requires electrodes having a suitable pore size for efficient access of the electrode surface by the electrolyte counterions. Electrochemical double-layer capacitors with high single cell voltages are not presently available commercially.

Currently used activated carbon electrodes are predominantly microporous (<2 nm) with low mesopore content. This has been shown to limit the electrodes' performance in both aqueous and organic electrolytes. A multimodal pore size distribution is desirable because such an interconnected network of mesopores (2-50 nm) and micropores (<2 nm) provides short ion diffusion distances and a higher charging density, which results in lower resistance and higher capacitance. With the combination of high surface area templated carbon and activation, the mesopore fraction improves electrolyte transport to the micropores. The optimum pore size is found to be that most similar to the size of the bare ion—smaller pores are inaccessible, while too large of a pore results in thicker double layer thickness. This reduces capacitance according to, C=kA/t, where A is the area and t is the double layer thickness.

Currently used activated carbon electrodes also use ˜15% binder, which further blocks porosity, leading to diminished energy storage capacity. Polymeric binders and conducting additives also add costs to the manufacture of the electrode.

In an effort to overcome the disadvantages exhibited by currently available carbon electrodes, the claimed invention uses activated carbon fibers that incorporate microporous and mesoporous carbon with appropriate pore sizes to maximize capacitance and minimize resistance. The porous carbon precursor is prepared using a template, followed by incorporation into a matrix polymer and the mixture is subjected to electrospinning. Subsequent thermal treatments retain the fiber form, and a composite carbon fiber incorporating templated porous carbon is attained. The resulting electrode is binder free and 100% electrochemically active. Energy densities up to 41 Wh/kg in energy density and 1.5 kW/kg in power density (electrode weight only) have been achieved.

### SUMMARY OF THE INVENTION

An embodiment of the invention is directed to an electrode made from carbon nanofibers, wherein the carbon nanofibers comprise a porous carbon material that is free of binder, and having a pore size ranging from 0.7 nm to 3 nm.

A further embodiment of the invention is directed to a method of forming a carbon nanofiber containing porous carbon, the method comprising, dispersing a mixture of a carbon precursor-filled pore-directing template and a matrix polymer using a combination of stirring and sonication; electrospinning the mixture to form a nonwoven web comprising fibers less than 1 μm in diameter; thermally stabilizing the web in air to preserve its fiber form via cyclization and/or crosslinking; heating the web in inert atmosphere to convert the fibers to carbon; activating the fibers using etchant gases or solution to increase surface area; and annealing under inert atmosphere to remove surface functionalities if necessary.

Another embodiment of the invention is directed to an electrochemical cell comprising a cathode, an electrolyte and an anode made from carbon nanofibers, said carbon nanofibers comprising a porous carbon material that is free of binder, wherein said porous carbon material has a pore size ranging from 0.7 nm to 3 nm.

### BRIEF DESCRIPTION OF THE DRAWINGS

Embodiments of the invention will be described, by way of example only, with reference to the drawings, in which:

FIG. 1 represents the scanning electron microscopy images of the template, the precursor-filled pore-directing template (PFPDT) and the resulting carbon fibers at different loadings of the PFPDT; (A) MOF-5 template, (B) MOF-5 with deposited polyfurfuraldehyde (pFA), (C) carbon fiber with 5% PFPDT, (D) carbon fiber with 10% PFPDT, (E) carbon fiber with 20% PFPDT, and (F) carbon fiber with 30% PFPDT.

FIG. 2 represents the nitrogen adsorption isotherms for the activated polyacrylonitrile (PAN) and pFA/MOF/PAN fibers;

FIG. 3 represents the pore size distribution for activated PAN and pFA/MOF/PAN fibers;

FIG. 4 represents specific capacitance for symmetric devices using annealed PAN and pFA/MOF/PAN fibers in EMIIm electrolyte; and

FIG. 5 represents energy and power densities (electrode weight only) of symmetric capacitor devices using carbon fibers in ionic liquid in accordance with embodiments of the invention.

### DESCRIPTION OF EXEMPLARY EMBODIMENTS

An embodiment of the claimed invention is directed to the production of carbon fibers with porosity sufficient to accommodate ionic liquid ions by using a pore-directing template such as metal-organic frameworks (MOFs), molecular sieves or zeolites. Metal-Organic Frameworks are crystalline compounds consisting of metal ions or clusters coordinated to often rigid organic molecules to form one-, two-, or three-dimensional structures that can be porous and possess a high surface area.

In an embodiment of the invention, the pore directing template that is used is MOF-5. MOF-5 is made up of 1,4-benzenedicarboxylate molecules joining Zn₄O clusters to form a cubic periodic porous framework.

The carbon fibers prepared in accordance with embodiments of the invention are typically a combination of mesoporous and microporous templated carbon in a polymer matrix. A microporous carbon is considered to have a major part of its porosity in pores of less than 2 nm width and exhibits apparent surface areas usually higher than 200 to 300 m² g⁻¹. Mesoporous carbon has a major part of its porosity in pores 2-50 nm.

In embodiments of the invention, the metal-organic frameworks that are used are crystalline compounds consisting of metal ions or clusters coordinated to rigid organic molecules to form one-, two-, or three-dimensional structures that can be porous.

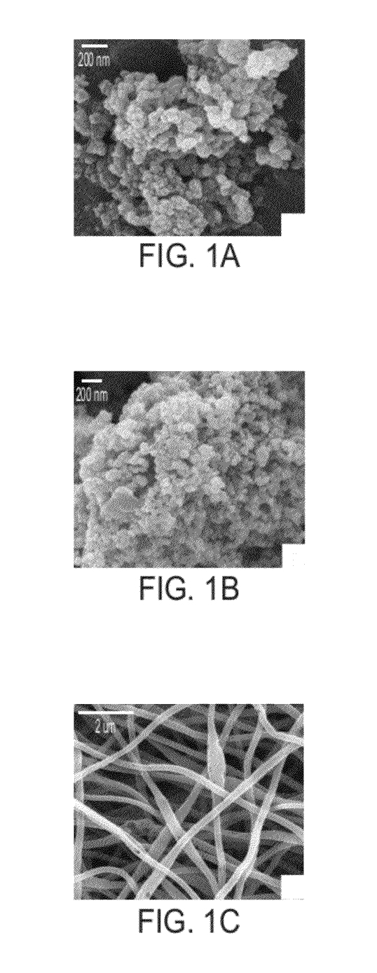

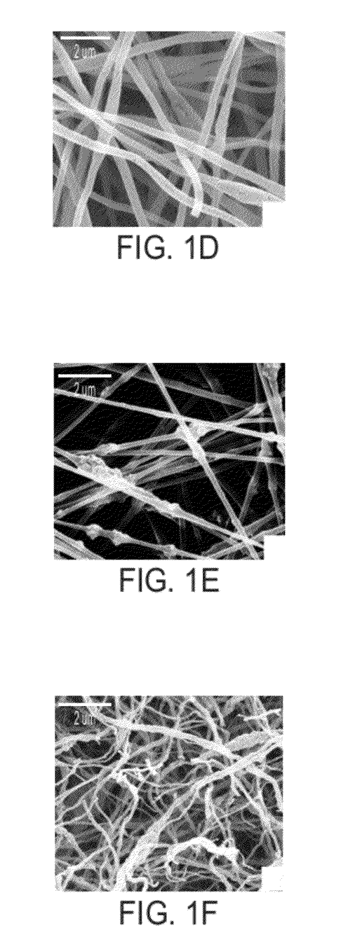

In an embodiment of the invention, a templating molecule such as a MOF, molecular sieve or zeolite is contacted with a carbon precursor and a polymer matrix. In an embodiment of the invention, the templating molecule is first contacted with a carbon precursor. Examples of carbon precursors used in embodiments of the invention include polyfurfuraldehyde, polyfurfuryl alcohol, sucrose and polypropylene. The carbon precursor can be introduced via vapor deposition polymerization or chemical vapor deposition, where the template is held at elevated temperature and is exposed to the vapors of the precursor. Alternately, the template is stirred with the liquid precursor, filtered and after polymerization affords a carbon with performance comparable to the vapor deposition method. FIG. 1A represents the scanning electron microscopy image of a sample template (MOF-5). FIG. 1B represents the scanning electron microscopy image of a MOF-5 template filled with a carbon precursor.

In an embodiment of the invention, the precursor-filled pore-directing template (PFPDT) is mixed with the matrix polymer using a combination of stirring and sonication and fibers are then electrospun. The electrospinning methods used in embodiments of the invention are in accordance with known methods in the art. The electrospinning solution is made up with a matrix polymer and a PFPDT. A PFPDT is first dispersed in a solvent that is compatible with the matrix polymer that is to be used for the specific application, by alternating stirring and sonication. The PFPDT dispersion is gradually added to a matrix polymer solution with heating to enhance dispersion of the PFPDT particles into the matrix polymer. After stirring at an elevated temperature, the solution is kept stirred until prior to electrospinning.

In certain embodiments of the invention, the matrix polymer is polyacrylonitrile (PAN), polybenzimidazole (PBI), Matrimid™ (polyimide), polyvinyl alcohol, lignin, cellulose acetate, or any other graphitizing electrospinnable polymer. In certain embodiments of the invention, dimethylformamide or similar solvents are used to prepare solutions of the matrix polymer, and to disperse the PFPDT.

An embodiment of the claimed invention presents a supercapacitor electrode/device that is prepared using carbon fibers that allow the use of ionic liquid electrolyte in high energy, high power devices. The carbon fiber of the claimed invention offers high surface area and more importantly, a pore size that matches ions of the ionic liquid electrolyte. In an embodiment of the invention, the pore size of the carbon material in the carbon fiber ranges from 0.7 nm to 3 nm.

In an embodiment of the invention, a battery or capacitor prepared in accordance with principles of the invention possess an energy density of 41 Wh/kg at 1.7 kW/kg across 3.5 V while the energy density for a battery or capacitor in a packaged single cell device is ˜23 Wh/kg across 3.5V. These results are far higher compared to ˜5 Wh/kg and 5 kW/kg for most currently available commercial carbon-based capacitors.

An embodiment of the invention provides a supercapacitor/battery electrode that can be used in stacked devices in portable consumer electronics, smart grid stationary power supply, car batteries in hybrid systems as a pulse power source to prolong battery life, and other similar applications.

An embodiment of the invention is directed to the fabrication of supercapacitor electrodes/devices using electrospinning of carbon fibers from polyacrylonitrile (PAN) or similar graphitizing polymers that incorporate pore-directing templates (PDT) such as molecular sieves including MOFs and ZIFs (zeolitic imidazolate frameworks).

In an embodiment of the invention, the precursor-filled pore-directing template (PFPDT) is electrospun with the matrix polymer following dispersion of the PFPDT in a solvent, using a combination of stirring and sonication.

In a further embodiment of the invention, the electrospinning process generates a nonwoven web comprising fibers less than 1 μm in diameter.

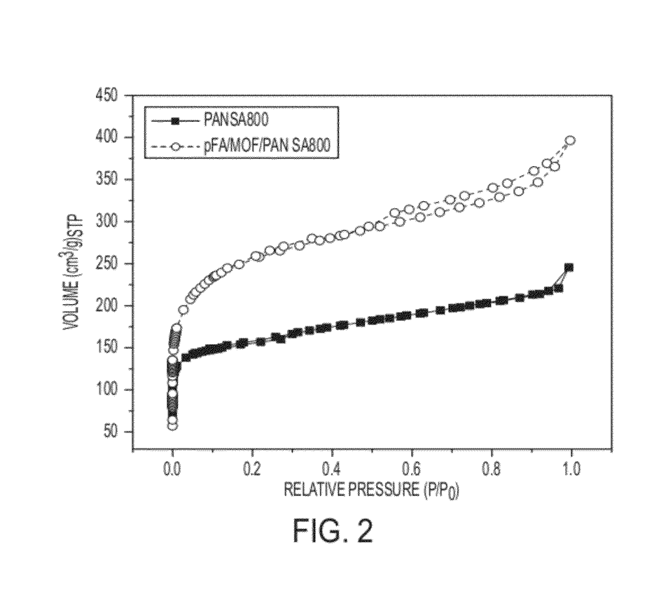

In an embodiment of the invention, the as-spun non-woven web is initially thermally stabilized in air to preserve the fiber form via cyclization and/or crosslinking. This step is followed by heating the fibrous web in an inert atmosphere to convert it to carbon. Following the conversion to carbon, the porosity of the fibers is increased (activation step) by exposure to steam or other gases such as CO₂ and NH₃ and other etchant gases and solutions at elevated temperatures. The resulting fibers have pores large enough to allow use as electrodes in capacitors utilizing ionic liquid electrolytes as well as aqueous or organic electrolytes. FIGS. 1C-1F represent the scanning electron microscopy images of carbon fibers produced by methods of the claimed invention comprising 5%, 10%, 20% and 30% of PFPDT. FIG. 2 represents the nitrogen adsorption isotherms for activated polyacrylonitrile (PAN) and pFA/MOF/PAN fibers produced in accordance with the methods of the invention.

In another embodiment of the invention, a PFPDT is carbonized first (i.e., contacted with a carbon precursor) followed by incorporation into a polymer matrix prior to electrospinning. The high surface area carbon can be introduced to the template by vapor deposition polymerization or by extended immersion of the template in the carbon source.

In an embodiment of the invention, the electrospinning solution comprises a matrix polymer and a PFPDT. The PFPDT is first dispersed in a solvent by alternating stirring and sonication. The solvent that is used to disperse the PFPDT is one that is also a solvent of the matrix polymer that is to be used in the electrospinning process. A preferred solvent is dimethylformamide. However, any solvent that is compatible with the matrix polymer may be used to disperse the PFPDT. The PFPDT dispersion is gradually added to the matrix polymer solution with heating to enhance dispersion of the PFPDT particles into the matrix polymer. After stirring at elevated temperature, the solution is continued to be stirred until prior to the electrospinning step.

Electrospinning is typically performed at a feed flow rate between 0.5-4.0 mL/hr, at a tip-to-collector distance between 5-20 cm, using 10-40 KV, onto a grounded collector under ambient conditions. The thickness of the mat is controlled by the duration of electrospinning over a fixed area. The electrospun mat can be stabilized by heating in air, and then further carbonized under inert gas. The carbonized mat is then activated at elevated temperatures using steam, CO₂, NH₃ and other etchant gases or solutions.

In certain embodiments of the invention, the activation step introduces surface functionalities onto the surface of the carbon and imparts polarity (acidic or basic). In such cases, the mat may be further heated under inert atmosphere to remove such functionalities, especially when the chosen electrolyte is hydrophobic. This step is done to match the polarity of the carbon surface with the polarity of the desired electrolyte.

In certain embodiments, a coin cell may be used for the fabrication of the device. Electrodes are cut from the mat and can be directly used as electrodes without mixing, use of binders or lamination.

An embodiment of the invention is directed to an electrochemical cell comprising a cathode, an electrolyte and an anode made from carbon nanofibers, said carbon nanofibers comprising a porous carbon material that is free of binder, wherein said porous carbon material has a pore size ranging from 0.7 nm to 3 nm.

In an embodiment of the invention, the electrolyte is an ionic liquid ethyl-methylimidazolium/trifluoro-methane-sulphonylimide (EMI-TFSI). In other embodiments of the invention, other ionic liquids such as 1-butyl-3-methylimidazolium hexafluorophosphate (BMIMPF₆), 1-ethyl-3-methylmidazolium bis(trifluoromethylsulfonyl)imide (EMIIm), aqueous electrolytes and organic electrolytes are used.

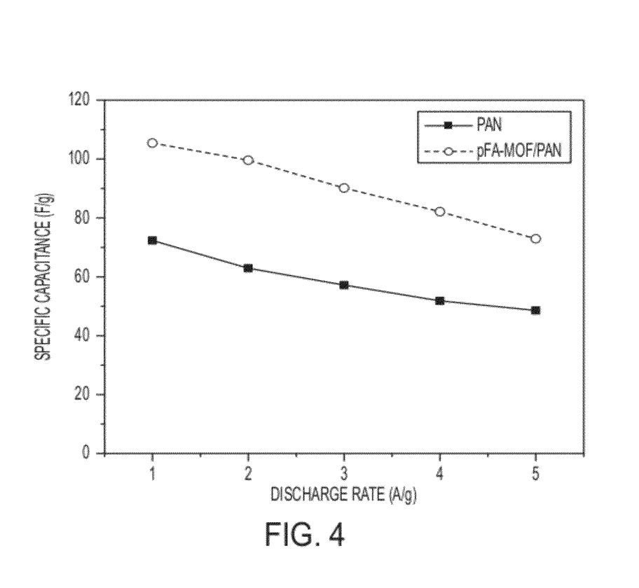

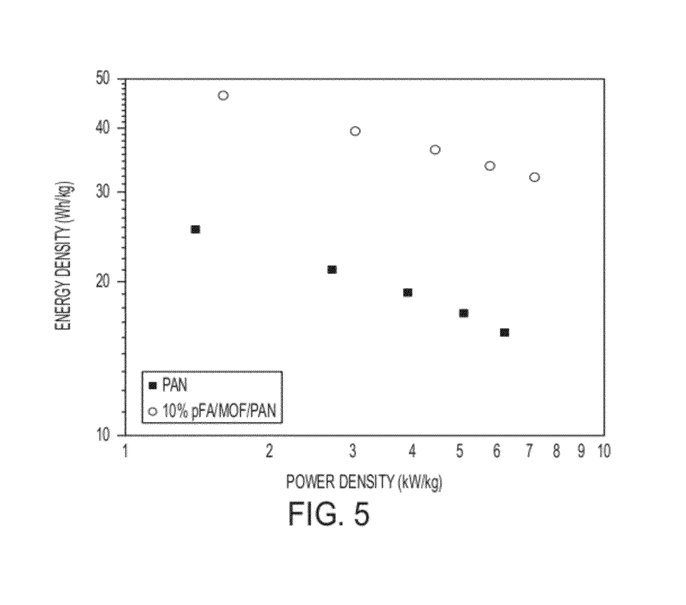

An embodiment of the claimed invention provides increased gravimetric and/or volumetric energy and power density in binder-free carbon capacitors. For example, FIG. 4 represents specific capacitance for symmetric devices using annealed PAN and pFA/MOF/PAN fibers in EMIIm electrolyte. FIG. 5 represents energy and power densities (electrode weight only) of symmetric capacitor devices using carbon fibers in ionic liquid in accordance with embodiments of the invention.

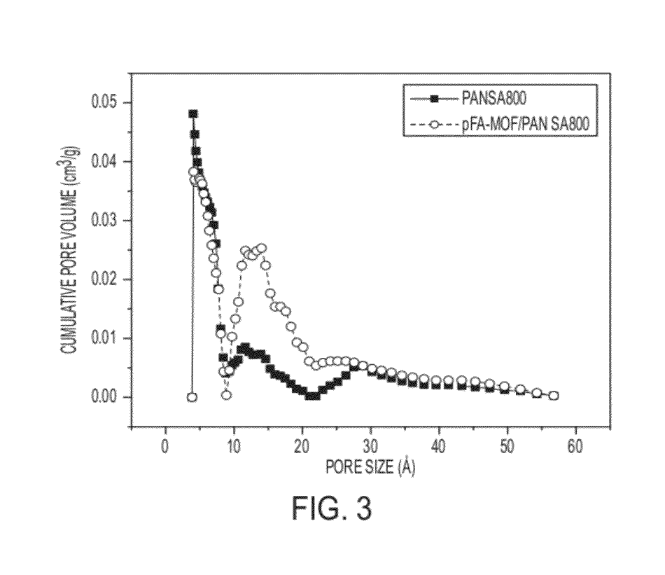

The claimed invention represents the first instance wherein porous templated carbon has been incorporated into carbon nanofibers. The tailored pore size matches the ion size, which in turn increases capacitance of the battery or capacitor that contains the porous template carbon. FIG. 3 represents the pore size distribution for activated PAN and pFA/MOF/PAN fibers produced in accordance with embodiments of the invention.

Additionally, incorporation of porous templated carbon increases the energy and power capability by several fold relative to non-porous carbon. An additional advantage of the invention is that the carbon electrodes produced by the methods of the invention are free of any inactive binders, which have a tendency to clog the pores of the electrodes. The binder-free carbon electrodes of the claimed invention possess a higher capacitance compared to traditional electrodes manufactured using binders.

In an embodiment of the invention, the porous carbon material formed in accordance with methods of the invention is incorporated into carbon nanofibers. The materials and dispersion technique used for the porous carbon material allows its incorporation into nanofibers (<1 μm). The incorporation of other carbon sources into nanofibers is usually not possible due to their bigger size and incompatibility with the electrospinning solvent.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality.

What is claimed is:

1. An electrode made from carbon nanofibers, said carbon nanofibers comprising a porous carbon material that is free of binder, wherein said porous carbon material has a pore size ranging from 0.7 nm to 3 nm.

2. The electrode of claim 1, wherein said porous carbon material is prepared by electrospinning a mixture of a templated carbon precursor and polymer.

3. The electrode of claim 2, wherein said templated carbon precursor is prepared by contacting a carbon precursor with a templating molecule.

4. The electrode of claim 2, wherein said polymer is selected from the group consisting of polyacrylonitrile, polybenzimidazole, polyimide, polyvinyl alcohol, lignin and cellulose acetate.

5. The electrode of claim 3, wherein the carbon precursor is selected from the group consisting of polyfurfuraldehyde, polyfurfuryl alcohol, sucrose and polypropylene.

6. The electrode of claim 3, wherein the templating molecule is selected from the group consisting of MOF, molecular sieve and zeolite.

5. A method of forming a porous carbon material, the method comprising,
dispersing a mixture of a carbon precursor-filled pore-directing template and a matrix polymer using a combination of stirring and sonication;
electrospinning the mixture to form a nonwoven web comprising fibers less than 1 μm in diameter;
thermally stabilizing the web in air to preserve its fiber form via cyclization or crosslinking; and
heating the web in a first heating step in inert atmosphere to convert the fibers to carbon.

6. The method of claim 5, further comprising the step of activating the fibers to increase their porosity.

7. The method of claim 6 wherein, the fibers are activated using steam, CO₂ or NH₃ at elevated temperatures.

8. The method of claim 6, further comprising a second heating step, wherein the fibers are heated in inert atmosphere after the activation step.

9. The method of claim 5 wherein, the matrix polymer is selected from the group consisting of polyacrylonitrile (PAN), polybenzimidazole (PBI), Matrimid™, polyvinyl alcohol, lignin and cellulose acetate.

10. The method of claim 5 wherein, the pore-directing template is selected from the group consisting of MOF, molecular sieve and zeolite.

11. The method of claim 5 wherein, the carbon precursor is selected from the group consisting of polyfurfuraldehylde, polyfurfuryl alcohol, sucrose and polypropylene.

12. An electrochemical cell comprising a cathode, an electrolyte and an anode made from carbon nanofibers, said carbon nanofibers comprising a porous carbon material that is free of binder, wherein said porous carbon material has a pore size ranging from 0.7 nm to 3 nm.

13. The electrochemical cell of claim 12, wherein said porous carbon material is prepared by electrospinning a mixture of a templated carbon precursor and polymer.

14. The electrochemical cell of claim 13, wherein said templated carbon precursor is prepared by contacting a carbon precursor with a templating molecule.

15. The electrochemical cell of claim 13, wherein said polymer is selected from the group consisting of polyacrylonitrile, polybenzimidazole, polyimide, polyvinyl alcohol, lignin and cellulose acetate.

16. The electrochemical cell of claim 14, wherein the carbon precursor is selected from the group consisting of polyfurfuraldehyde, polyfurfuryl alcohol, sucrose and polypropylene.

17. The electrochemical cell of claim 14, wherein the templating molecule is selected from the group consisting of MOF, molecular sieve and zeolite.

18. The electrochemical cell of claim 12, wherein said electrochemical cell is a battery.

19. The electrochemical cell of claim 12, wherein said electrochemical cell is a supercapacitor.

20. The electrochemical cell of claim 12, wherein said electrolyte is 1-ethyl-3-methylmidazolium bis(trifluoromethylsulfonyl)imide.
